(19) United States
(12) Patent Application Publication
(10) Pub. No.: US 2007/0168241 A1
(43) Pub. Date: Jul. 19, 2007

(54) Survey-based management performance evaluation systems

(75) Inventor: Owen S. Robbins, Fountain Hills, AZ (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Benchmark Integrated Technologies, Inc.

(21) Appl. No.: 11/336,118

(22) Filed: Jan. 19, 2006

(51) Int. Cl. G06Q 10/00

(52) U.S. Cl. 705/7

(57) ABSTRACT

A system for use in evaluating the performance of an individual, the system being adapted for: (A) analyzing a first set of data to determine: (1) at least one target area for improvement, and (2) a first target area performance measurement that corresponds to a particular measurement of performance within the target area at a first particular time; (B) receiving a recommendation of a course of action intended to produce a measurable improvement in the particular measurement of performance; (C) after the implementation of the course of action, receiving a second target area performance measurement that corresponds to the particular measurement of performance within the target area at a second particular time, the second particular time being after the occurrence of the implementation of the course of action; (D) using the first and second target area performance measurements to determine a change in the particular measurement of performance; and (E) conveying the change to a user.

### BACKGROUND OF THE INVENTION

Survey techniques have been used in the past to assess the opinions of individuals in areas, such as politics and new product development, in which public opinion can be crucial to the success of a particular effort. However, there currently exists a need for improved survey techniques, and for improved techniques for using survey methodologies within other areas, such as management evaluation, in order to evaluate and enhance management performance.

### SUMMARY OF VARIOUS EMBODIMENTS OF THE INVENTION

A computer system according to various embodiments of the invention comprises at least one computer processor, and is adapted for: (1) analyzing a first set of data to determine: (a) at least one target area for improvement, and (b) a first target area performance measurement that corresponds to a particular measurement of performance within the target area at a first particular time; (2) receiving a recommendation of a specific course of action that is intended to produce a measurable improvement in the particular measurement of performance; (3) receiving a quantified estimate of the effect that the implementation of the specific course of action would have on the particular measurement of performance, the quantified estimate being made by an individual and comprising a predicted change in the particular measurement of performance; (4) receiving a second set of data; (5) using the second set of data to determine a second target area performance measurement that corresponds to the particular measurement of performance within the target area at a second particular time, the second particular time being after an implementation of the specific course of action; (6) comparing the second target area performance measurement with the first target area performance measurement to determine an actual change in the particular measurement of performance; and (7) conveying, to a user, a comparison of the actual change with the predicted change. In various embodiments, the “second particular time” is after the completion of the specific course of action.

In certain embodiments, the system is further adapted for: (1) generating a first survey; (2) distributing the first survey to a plurality of survey participants; (3) receiving, from the plurality of survey participants, a set of results of the first survey, the set of results of the first survey comprising the first set of data; (4) executing the step of analyzing the first set of data after the step of receiving the set of results of the first survey; (5) generating a second survey; (6) distributing the second survey to a manager; (7) receiving, from the manager, a set of results of the second survey, the set of results of the second survey comprising the recommendation of the specific course of action and the quantified estimate of the effect that the implementation of the specific course of action would have on the particular measurement of performance; (8) executing the step of conveying the comparison to the user after the step of receiving the set of results of the second survey; (9) generating a third survey; (10) distributing the third survey to the plurality of survey participants; (11) receiving, from the plurality of survey participants, a set of results of the third survey, the set of results of the third survey comprising the second set of data; and/or (12) executing the step of using the second set of data to determine a second target area performance measurement after the step of receiving the set of results of the third survey.

In various embodiments: (1) the step of distributing the first survey comprises distributing the first survey via e-mail; (2) the step of receiving the set of results of the first survey comprises receiving the set of results of the first survey from the plurality of survey participants via e-mail; (3) the step of distributing the second survey comprises distributing the survey via e-mail; (4) the step of receiving the set of results of the second survey comprises receiving the set of results from the employee via e-mail; and/or (5) the step of distributing the third survey comprises distributing the third survey via e-mail.

A system for use in evaluating the performance of an individual according to further embodiments of the invention is adapted for: (1) generating a survey regarding at least one particular topic; (2) distributing the survey to a plurality of survey participants; (3) receiving a set of results of the survey; (4) analyzing the set of results to identify: (a) at least one target area for improvement, and (b) a first target area performance measurement that corresponds to a particular measurement of performance within the target area at a first particular time; (5) receiving a quantified estimate of the effect that the completion of a particular course of action would have on the particular measurement of performance within the target area, the quantified estimate being made by the individual and comprising a predicted change in the particular measurement of performance within the target area; (6) distributing the quantified estimate to at least one superior of the individual; (7) after the completion of a particular course of action, receiving a second target area performance measurement that corresponds to the particular measurement of performance within the target area at a second particular time, the second particular time being after the completion of a particular course of action; (8) comparing the second target area performance measurement with the first target area performance measurement to determine an actual change in the particular measurement of performance within the target area; and (9) generating a comparison of the actual change in the particular measurement of performance with the predicted change. The system may also be configured for distributing the comparison to the individual's superior.

A system according to yet another embodiment of the invention is adapted for: (1) analyzing a first set of data to determine: (a) at least one target area for improvement, and (b) a first target area performance measurement that corresponds to a particular measurement of performance within the target area at a first particular time; (2) receiving a recommendation of a specific course of action that would produce a measurable improvement in the particular measurement of performance; (3) after the implementation of the specific course of action, receiving a second target area performance measurement that corresponds to the particular measurement of performance within the target area at a second particular time, the second particular time being after the occurrence of the implementation of the specific course of action; (4) using the second target area performance measurement and the first target area performance measurement to determine a change in the particular measurement of performance; and (5) conveying the change to a user.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram of a system according to a particular embodiment of the invention.

FIG. 2 is a diagram of a Survey Server according to one embodiment of the invention.

FIG. 3 is a flowchart illustrating the steps executed by an Initial Survey Generation and Distribution Module according to one embodiment of the invention.

FIG. 4 is a flowchart illustrating the steps executed by an Initial Survey Results Processing and Distribution Module according to various embodiments of the invention.

FIG. 5 is a flowchart illustrating the steps executed by an Action Planning Survey Generation and Distribution Module according to a particular embodiment of the invention.

FIG. 6 is a flowchart illustrating the steps executed by an Action Planning Survey Results Processing and Distribution Module according to one embodiment of the invention.

FIG. 7 is a flowchart illustrating the steps executed by an Action Planning Follow Up Module according to a particular embodiment of the invention.

FIG. 8 is a graphical representation of the results of a particular survey according to a particular embodiment of the invention.

FIG. 9 is a graphical representation of the results of a particular survey according to another embodiment of the invention.

FIG. 10 is a graphical representation of the change in percent satisfaction resulting from action planning according to a particular embodiment of the invention.

### DETAILED DESCRIPTION OF VARIOUS EMBODIMENTS OF THE INVENTION

The present invention now will be described more fully with reference to the accompanying drawings, in which some, but not all embodiments of the invention are shown. Indeed, this invention may be embodied in many different forms and should not be construed as limited to the embodiments set forth herein. Rather, these embodiments are provided so that this disclosure will satisfy applicable legal requirements. Like numbers refer to like elements throughout.

As will be appreciated by one skilled in the relevant field in view of this disclosure, the present invention may be embodied as a method, a data processing system, or a computer program product. Accordingly, the present invention may take the form of an entirely hardware embodiment, an entirely software embodiment, or an embodiment combining software and hardware aspects. Furthermore, the present invention may take the form of a computer program product on a computer-readable storage medium having computer-readable program instructions (e.g., computer software) embodied in the storage medium. More particularly, the present invention may take the form of web-implemented computer software. Any suitable computer-readable storage medium may be utilized including hard disks, CD-ROMs, optical storage devices, or magnetic storage devices.

Various embodiments of the present invention are described below with reference to block diagrams and flowchart illustrations of methods, apparatuses (e.g., systems) and computer program products according to various embodiments of the invention. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

System Architecture

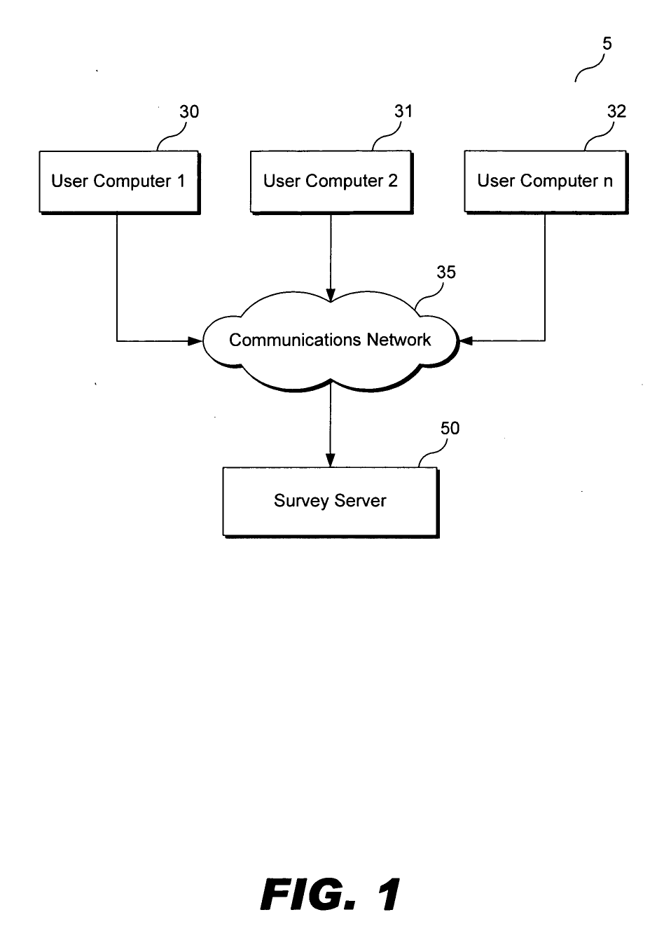

A Survey System 5 according to one embodiment of the invention is shown in FIG. 1. As may be understood from this figure, in this embodiment, the system includes one or more user computers 30, 31, 32 that are connected, via a communications network 35 (e.g., a LAN or a global communications network such as the Internet), to communicate with a Survey Server 50. In a particular embodiment, the first user computer 30 is a survey designer computer and the second user computer 31 is a customer computer. In one embodiment of the invention, the Survey Server 50 is configured for retrieving data from and storing data to a database (not shown) that may be stored on (or, alternatively, stored remotely from) the Survey Server 50.

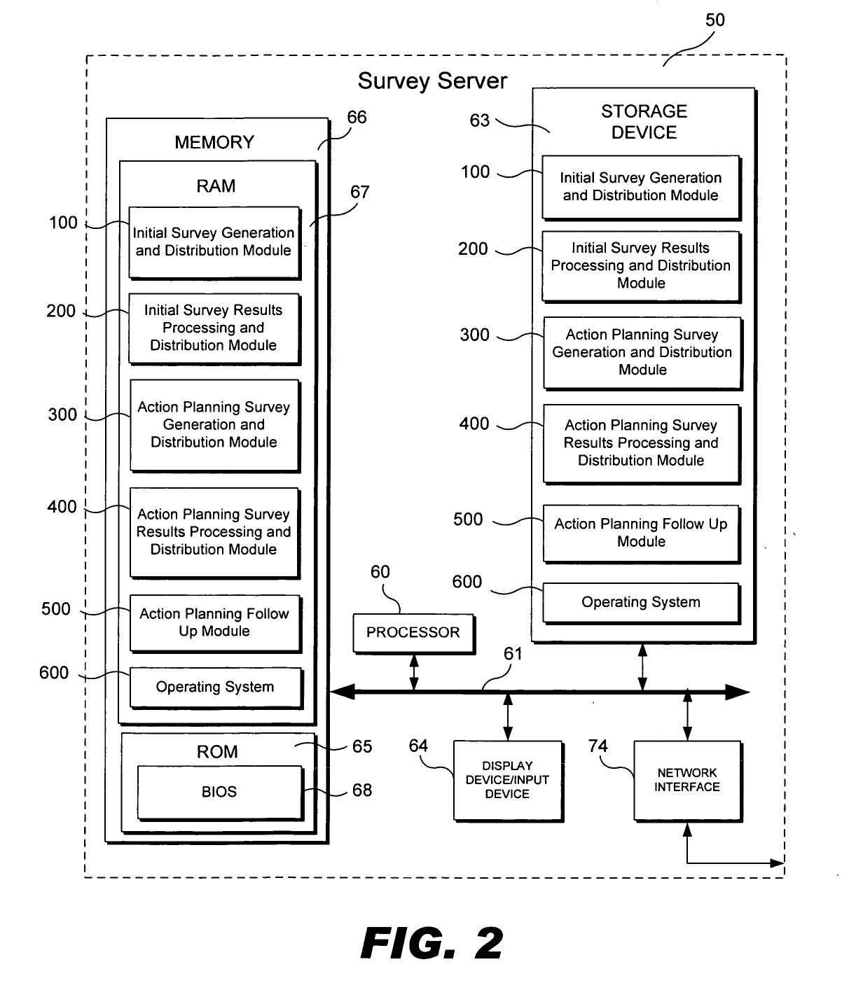

FIG. 2 shows a schematic diagram of a Survey Server 50 according to one embodiment of the invention. In this embodiment, the Survey Server 50 includes a processor 60 that communicates with other elements within the Survey Server 50 via a system interface or bus 61. Also included in the Survey Server 50 is a display device/input device 64 for receiving and displaying data. This display device/input device 64 may be, for example, a keyboard or pointing device that is used in combination with a monitor. The Survey Server 50 further includes memory 66, which preferably includes both read only memory (ROM) 65 and random access memory (RAM) 67. The server's ROM 65 is used to store a basic input/output system 68 (BIOS), containing the basic routines that help to transfer information between elements within the Survey Server 50.

In addition, the exemplary Survey Server 50 includes at least one storage device 63, such as a hard disk drive, a floppy disk drive, a CD Rom drive, or optical disk drive, for storing information on various computer-readable media, such as a hard disk, a removable magnetic disk, or a CD-ROM disk. As will be appreciated by one of ordinary skill in the art, each of these storage devices 63 is preferably connected to the system bus 61 by an appropriate interface. The storage devices 63 and their associated computer-readable media provide nonvolatile storage for a personal computer. It is important to note that the computer-readable media described above could be replaced by any other type of computer-readable media known in the art. Such media include, for example, magnetic cassettes, flash memory cards, digital video disks, and Bernoulli cartridges.

A number of program modules may be stored by the various storage devices and within RAM 67. Such program modules include an operating system 600, an Initial Survey Generation and Distribution Module 100, an Initial Survey Results Processing and Distribution Module 200, an Action Planning Survey Generation and Distribution Module 300, an Action Planning Survey Results Processing and Distribution Module 400, and an Action Planning Follow Up Module 500. The Initial Survey Generation and Distribution Module 100, Initial Survey Results Processing and Distribution Module 200, Action Planning Survey Generation and Distribution Module 300, Action Planning Survey Results Processing and Distribution Module 400, and Action Planning Follow Up Module 500 control certain aspects of the operation of the Survey Server 50, as is described in more detail below, with the assistance of the processor 60 and an operating system 600.

Also located within the Survey Server 50 is a network interface 74, for interfacing and communicating with other elements of a computer network. It will be appreciated by one of ordinary skill in the art that one or more of the Survey Server 50 components may be located geographically remotely from other Survey Server 50 components. Furthermore, one or more of the components may be combined, and additional components performing functions described herein may be included in the Survey Server 50.

Brief Overview of Exemplary System Flow

A survey system according to various embodiments of the invention is adapted to: (1) generate and, optionally, distribute a survey; (2) receive the results of the survey; (3) process the results of the survey and, optionally, distribute the results of the survey to one or more managers within an organization; and (4) generate and, optionally, distribute an action planning survey to the one or more managers within the organization. In various embodiments, this action planning survey requires at least one manager to provide a recommended course of action for addressing one or more target areas, as well as a quantified estimate as to what effect the occurrence of the implementation of the course of action (e.g., the addition of 200 more parking spaces within a particular apartment building) would have on one or more measurable types of data (e.g., tenant satisfaction with parking, or tenant renewal rates).

Next, the system receives the results of the action planning survey and, optionally, distributes the results to one or more superiors of the manager (or managers) who completed the action planning survey. Next, after the recommended course of action has been implemented, the system receives an updated set of the “measurable type of data” referenced above. The system then compares this updated set of data with the original set of data (which may, for example, have been derived from the initial survey, or from another source) to determine the actual change in the data. The system then compares the actual change in the data with the manager's predicted change in the data, and generates a report that includes the results of this comparison. This report is then sent to the manager's superiors and then used, for example, to evaluate the manager's job performance.

Detailed Discussion of Exemplary System Flow

In various embodiments, the system may accomplish the above system flow by executing, for example: (1) an Initial Survey Generation and Distribution Module 100; (2) an Initial Survey Results Processing and Distribution Module 200; (3) an Action Planning Survey Generation and Distribution Module 300; (4) an Action Planning Survey Results Processing and Distribution Module 400; and (5) an Action Planning Follow Up Module 500. The operation of exemplary embodiments of each of these various modules is described in detail below.

Initial Survey Generation and Distribution Module

In various embodiments of the invention, the system's Initial Survey Generation and Distribution Module 100 is configured for: (1) receiving survey questions from a user; (2) incorporating these survey questions into an survey (e.g., an electronic or paper survey); and/or (3) distributing the survey to users (e.g., via e-mail, a web site, or paper mailing).

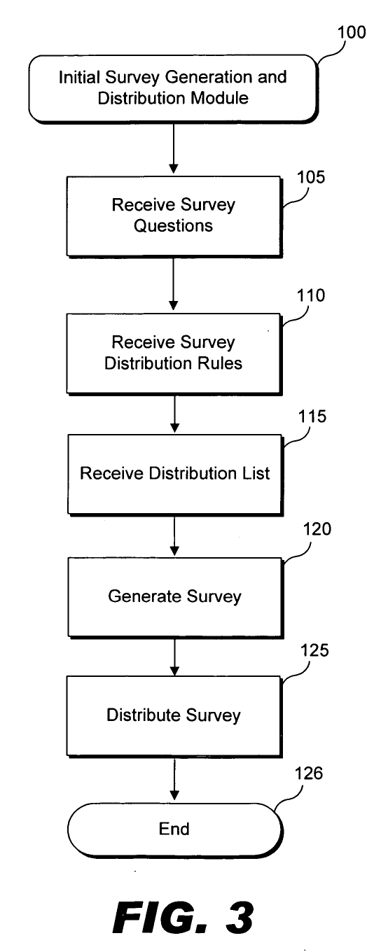

For example, the Initial Survey Generation and Distribution Module 100 of FIG. 3 begins at Step 105, where it receives a series of survey questions from a survey designer. In various embodiments, the system may receive this information (and other information discussed herein) through an appropriate computer-based interface with the user, such as an appropriate Internet-based graphical user interface. In alternative embodiments, the system may, for example, receive this information (and other information discussed herein) via manual entry by a customer support representative who has received the information from the survey developer or other user over the phone or in paper format.

In particular embodiments, the survey questions may include, for example, questions regarding the survey taker's satisfaction with one or more particular topics, and the relative importance of each of the particular topics to the survey taker. For example, if the survey is to be distributed to a tenant of a building to determine the tenant's level of satisfaction in various areas regarding their tenancy within the building, the survey questions may ask each tenant to list their current satisfaction with: (1) the cleanliness of the building; (2) the building's grounds; (3) the building's appearance; (4) the building's HVAC system; (5) parking at the building; and/or (6) the building's amenities. The survey questions may also ask each tenant how important each of these areas is to them (e.g., on a scale of 1 to 5). In addition, the survey questions may ask the survey taker for comments in regard to one or more particular topics, such as those listed above.

In various embodiments, the survey questions may also include questions regarding the user. For example, the questions may request information regarding the survey taker's: (1) residence; (2) occupation; (3) gender; (4) parking habits; and/or (5) habits regarding the use of a particular building's amenities.

Next, the system advances to Step 110, where it receives a set of survey distribution rules (e.g., from the survey designer). These survey distribution rules may specify, for example: (1) when the survey is to be distributed; and (2) the deadline by which the survey results must be received back from the various survey takers.

The system then progresses to Step 115, where it receives a list of individuals to whom the survey is to be distributed. In various embodiments of the invention, this survey distribution list may include an e-mail address for at least one of the survey takers (and preferably for each survey taker) to whom the survey is to be distributed. In various embodiments, having access to such information allows the system to distribute the survey directly to the various survey takers via e-mail.

Next, the system advances to Step 120, where it generates a survey that includes at least some (and preferably all) of the questions received by the system at Step 105. In various embodiments, the system generates the survey by applying a set of pre-specified survey formatting rules (e.g., a default set of survey formatting rules) that specify, for example, (1) the font of the text displayed in the survey; and (2) the format according to which the survey's various questions and answers are to be displayed to the user.

Next, at Step 125, the system distributes the survey to the individuals indicated within the list of individuals that the system received at Step 115. As noted above, the system may distribute the survey, for example, via e-mail or an appropriate web site. Alternatively, the system may facilitate the distribution of the survey by standard mail by printing paper copies of the survey and/or by generating mailing labels to be used in sending the survey to the various survey takers via U.S. mail. The survey takers may then complete the survey and submit their completed survey to the system for processing (e.g., via e-mail, a web site, or return mail).

Initial Survey Results Processing and Distribution Module

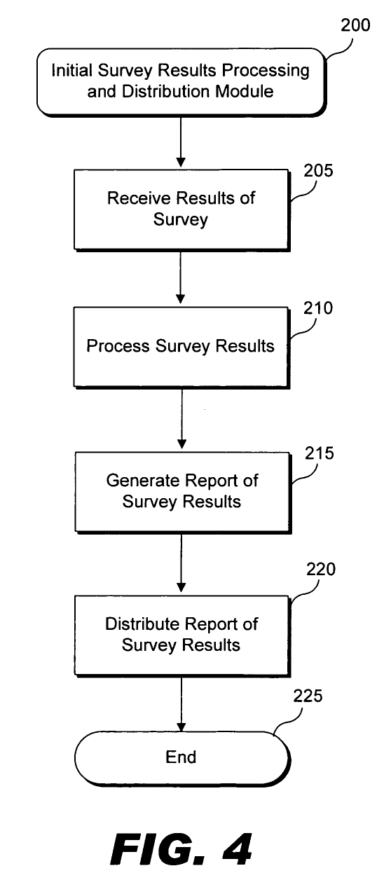

In various embodiments of the invention, after the system completes execution of the Initial Survey Generation and Distribution Module 100, the system executes an Initial Survey Results Processing and Distribution Module 200. As may be understood from FIG. 4, in various embodiments of the invention, the Initial Survey Results Processing and Distribution Module 200 begins at Step 205, where it receives the results of the survey generated at Step 105, above.

After receiving the results of the survey, the system proceeds to Step 210 where it processes the results of the survey. For example, for one or more of the questions, the system calculates the average satisfaction/relative importance ratio for the question. In various embodiments, the system does this by: (1) for each individual answer to the question, determining a satisfaction/relative importance ratio by dividing the indicated satisfaction score by the relative importance score for the question; and then (2) dividing the sum of all of the calculated satisfaction/relative importance ratios by the total number of answers to the question that were received by the system. The system may then use this (or other) information to automatically identify one or more particular target areas (e.g., areas in which it would be desirable to obtain an improvement). For example, the system may be configured to designate any topic having an average satisfaction/relative importance ratio that is less or greater than a predetermined threshold value (e.g., less than 1) as a “target area”.

For example, in a particular embodiment of the invention, the survey may have asked a survey taker to indicate both their satisfaction with, and the relative importance of, the cleanliness of a particular building. In one embodiment, the survey may have asked the survey taker to indicate their satisfaction with the building's cleanliness on a scale of 1 to 5 (e.g., 5 indicating that the survey taker is very satisfied with the building's cleanliness, and 1 indicating that the survey taker is very dissatisfied with the building's cleanliness). Similarly, in various embodiments, the survey taker may have asked the user to indicate the relative importance of the building's cleanliness to the survey taker on a scale of 1 to 5 (e.g., 5 indicating that the building's cleanliness is very important to the survey taker, and 1 indicating that the building's cleanliness is unimportant to the survey taker). In this example, if the system only received two answers to this question including: (1) a first answer indicating a 4 for satisfaction and a 2 for importance; and (2) a second answer indicating a 3 for satisfaction and a 3 for importance, the system would calculate the average satisfaction/relative importance ratio for the question as follows: Average Satisfaction/Average Importance=[(4+3)/2]/[(2+3)/2)]=(3.5+2.5)/2=1.4. In this embodiment, since the average satisfaction/relative importance ratio for the question is greater than a pre-determined threshold (e.g., of 1), the system would not identify this area as a “target area”. However, if the average satisfaction/relative importance ratio would have been less than the pre-determined threshold (e.g., less than 1), the system would have identified this area as a target area (e.g., by updating a database to indicate that the area should be considered to be a target area.) The system may then repeat this process for other (e.g., all) other questions in the survey.

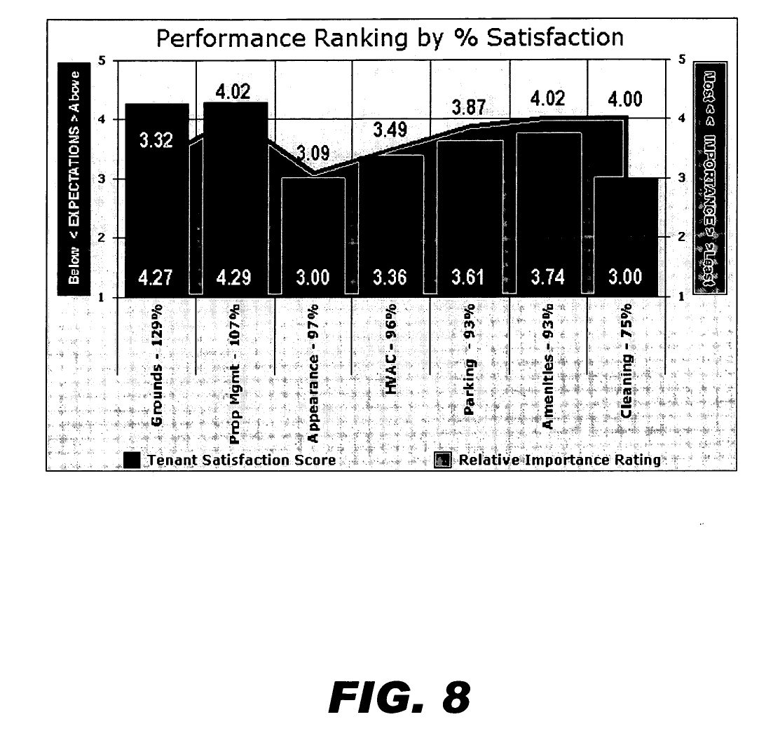

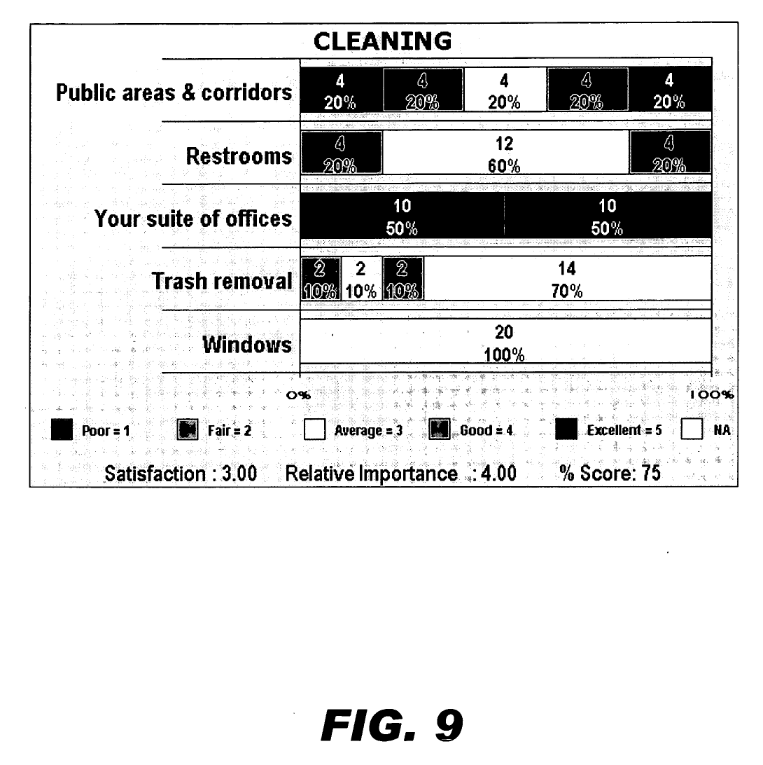

Next, after the system has processed the results of the survey, the system proceeds to Step 215 where it generates a report of the survey results. For example, the system may generate a report that includes the survey results for each question in a numerical and/or graphical format. (Examples of such reports are shown in FIGS. 8 and 9). Similarly, the report may include any comments received from the various survey takers in regard to one or more particular questions. In a particular embodiment, the report lists all (or substantially all) of the comments for a particular question within a single section of the report (e.g., on a single page). This may help users quickly review the various comments for a particular question.

Next, after the system has generated a report of the survey results, the system proceeds to Step 220 where it distributes the survey results. In various embodiments, the system may distribute the survey results, for example, via e-mail or a web site. Alternatively, the system may facilitate the distribution of the results of the survey, for example, via standard mail by printing paper copies of the survey results and/or by generating mailing labels to be used in distributing the survey results via U.S. mail.

In various embodiments, the system is configured to distribute the results of the survey to individuals designated by the survey designer when the survey designer submitted questions and rules for the survey. Alternatively, the system may be programmed to distribute each set survey results to a pre-determined group of individuals.

Action Planning Survey Generation and Distribution Module

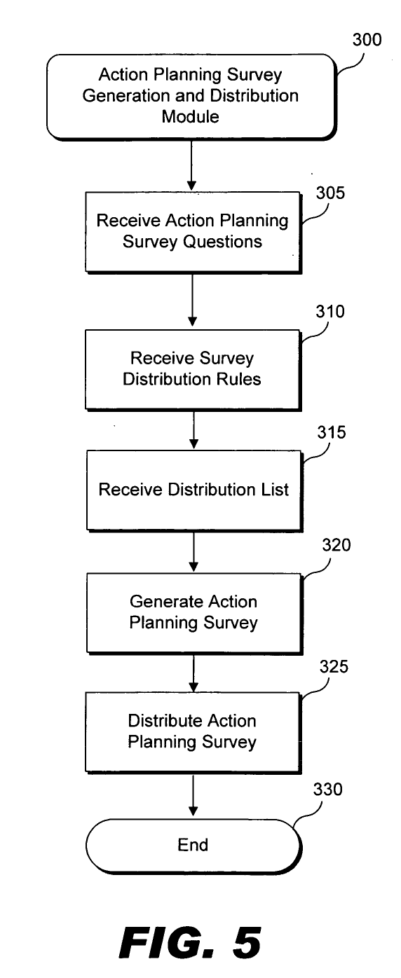

Next, after the system executes the Initial Survey Results Processing and Distribution Module 200, the system may, in various embodiments, execute an Action Planning Survey Generation and Distribution Module 300. As may be understood from FIG. 5, in various embodiments, when executing the Action Planning Survey Generation and Distribution Module 300, the system begins at Step 305 where it receives a series of action planning survey questions from a survey designer. These questions are preferably designed to assist a particular individual (e.g., a property manager, community manager, and/or asset manager who is in charge of managing a particular property) to develop a plan of action for addressing any topics that the system identified as target areas when executing the Initial Survey Results Processing and Distribution Module 200. For example, in various embodiments, for each “target area” identified by the system, the manager may be asked to: (1) define the extent of the problem; (2) identify one or more specific sources of the survey takers' dissatisfaction in the area at issue; (3) assess the impact that the problem is having on measurable data (such as tenant renewal rates, or the rate at which new leases are being signed for a particular property); (4) identify a specific course of action (e.g., one or more particular steps) to resolve the problem; (5) specify a date when the problem will be resolved (e.g., when the specific course of action will be complete); (6) provide a quantified estimate of the effect that the implementation of the specific course of action would have on a particular measurement of performance (e.g., tenant renewal rates, tenant satisfaction in a particular area, and/or the rate at which new leases are being signed for a particular property)—in various embodiments, this measurement of performance data (or data that the system could use to calculate this performance data) will have been received by the system, for a first particular time period, at Step 205; and/or (6) the cost of resolving the problem. If the manager taking the action planning survey does not believe that it is possible to resolve the problem, they may be asked what other steps will be taken to address the survey takers' concerns.

Next, after receiving the action planning survey questions at Step 305, the system advances to Step 310 where it receives a set of action planning survey distribution rules (e.g., from an action planning survey designer). These survey distribution rules may specify, for example: (1) when the survey is to be generated; and (2) the deadline by which the survey results must be received back from the managers (or other individuals) who will be completing the action planning survey.

The system then progresses to Step 315, where it receives a list of one or more individuals to whom the survey is to be distributed. In various embodiments of the invention, this survey distribution list may include an e-mail address for at least one (an preferably all) of the managers to whom the action planning survey is to be distributed. In various embodiments, having access to such information allows the system to distribute the survey directly to the various action planning survey takers via e-mail.

Next, the system advances to Step 320, where it generates an action planning survey that includes at least some (and preferably all) of the questions received by the system at Step 305. In various embodiments, the system generates the action planning survey, for example, by applying a set of pre-specified survey formatting rules (e.g., a default set of survey formatting rules) that specify, for example, (1) the font of the text displayed in the action planning survey; and (2) the format according to which the action planning survey's various questions and answers are to be displayed to the user.

Next, at Step 325, the system distributes the action planning survey to the individuals indicated within the list of individuals that the system received at Step 315. As noted above, the system may distribute the action planning survey, for example, via e-mail or a web page. Alternatively, the system may facilitate the distribution of the action planning survey, for example, via standard mail by printing paper copies of the action planning survey and/or by generating mailing labels to be used in sending the action planning survey to the various action planning survey taker(s) via U.S. mail. The appropriate managers (or other individuals) may then complete the survey and submit their completed action planning surveys to the system for processing (e.g., via e-mail, a web site, or by return mail).

Action Planning Survey Results Processing and Distribution Module

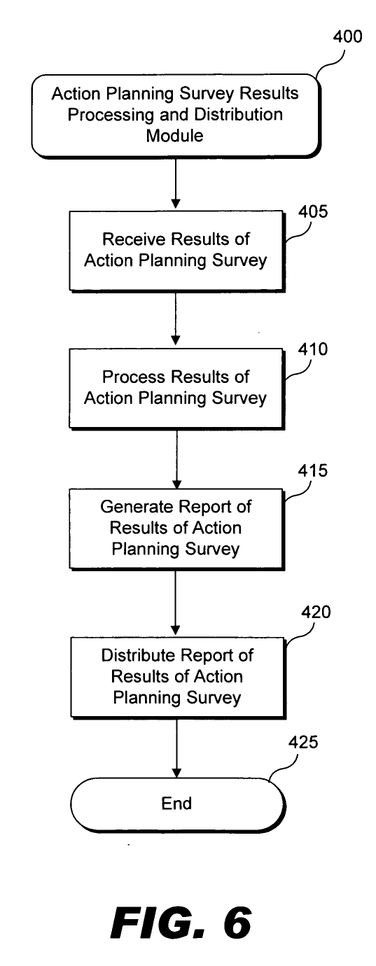

In various embodiments of the invention, after the system completes execution of the Action Planning Survey Generation and Distribution Module 300, the system executes an Action Planning Survey Results Processing and Distribution Module 400. As may be understood from FIG. 6, in various embodiments of the invention, the Initial Survey Action Planning Survey Results Processing and Distribution Module 400 begins at Step 405, where it receives the results of the action planning survey generated at Step 305.

After receiving the results of the survey, the system proceeds to Step 410 where it processes the results of the action planning survey. Next, the system proceeds to Step 415 where it generates a report of the various action planning survey results. For example, the system may generate a report in which a particular manager's action plan is presented in summary form.

Next, the system proceeds to Step 420 where it distributes the results of the action planning survey. In various embodiments, the system may distribute the action planning survey results (e.g., within the report describe above) via e-mail or a suitable web site. Alternatively, the system may facilitate the distribution of the results of the action planning survey via standard mail by printing paper copies of the survey and/or by generating mailing labels to be used in sending the action planning survey results via U.S. mail. In various embodiments, the system is configured to distribute the results of the survey to individuals designated by the survey designer when the survey designer submitted questions and rules for the action planning survey. Alternatively, the system may be programmed to distribute each set of survey results to pre-determined group of individuals. Such individuals may include, for example, one or more superiors of one or more of the managers who completed the action planning survey. The recipients of the action planning survey results may then use the results, for example, for budget planning purposes, and/or for evaluating the job performance of the managers who completed the action planning survey.

Action Planning Follow Up Module

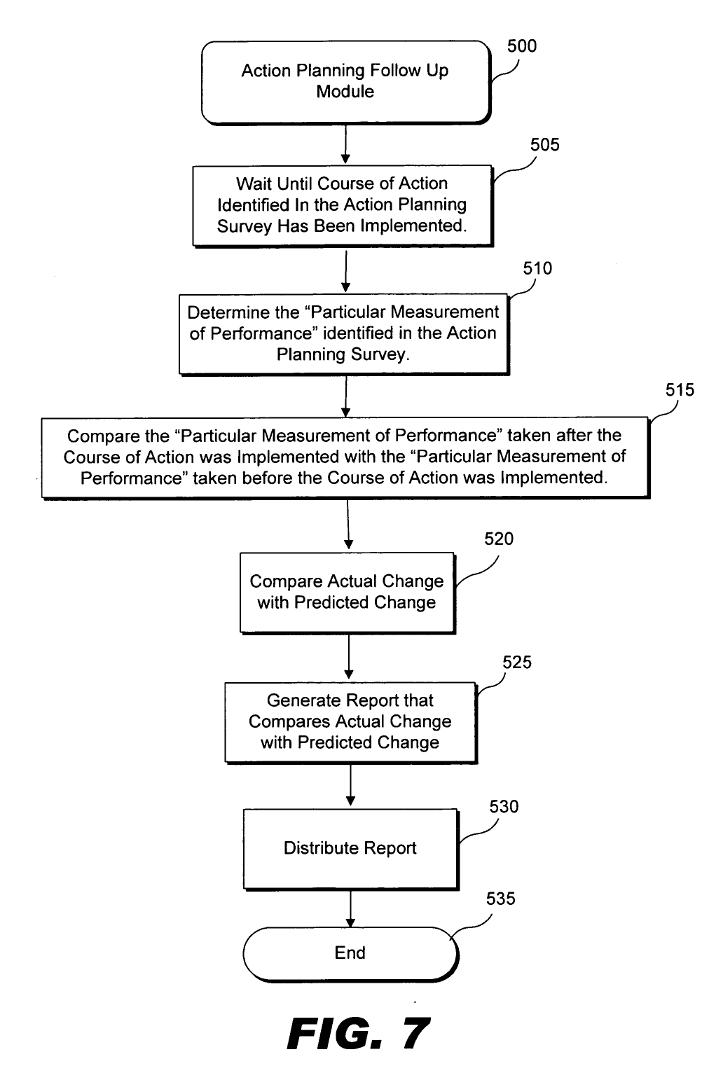

In various embodiments, after the system has executed the Action Planning Survey Results Processing and Distribution Module 400, the system executes an Action Planning Follow Up Module 500. As may be understood from FIG. 7, when executing this module, the system first advances to Step 505 where it waits until the particular course of action proposed by a manager completing the Action Planning Survey (“the manager”) has been implemented (e.g., completed). The system may do this, for example, by simply waiting until the date that was specified by the manager as being the date by which the course of action would be complete. Alternatively, the system may receive information (e.g., via a manual input by a user, or via an electronic exchange with an appropriate computer system) indicating that the proposed course of action has been implemented and/or completed.

In response to the system determining that the course of action proposed by the manager in the manager's Action Planning Survey has been implemented (e.g., completed), the system advances to Step 510 where it determines the “particular measurement of performance” that the manager indicated (e.g., via the action planning survey) would be affected by the proposed course of action. For example, if the manager had indicated that a particular building's tenant renewal rate would increase by 15% due to a specific course of action (e.g., the addition of a gym to the building), the system would determine the “particular measurement of performance” (here, the building's tenant renewal rate) after the implementation of the specific course of action (e.g., the addition of the gym to the building). In various embodiments, the system may determine the “particular measurement of performance” by, for example, generating, distributing, and receiving the results of a new survey in the manner described above in regard to the Initial Survey Generation and Distribution Module 200. Alternatively, the system may receive this information from another source, such as an appropriate computer system.

Next, the system advances to Step 515 where it compares the “particular measurement of performance” as taken after the specific course of action was implemented with the “particular measurement of performance” before the specific course of action was implemented. In various embodiments, while making this comparison, the system will calculate the actual change in the particular measurement of performance. For example, the system may calculate the actual percentage change in the particular measurement of performance that occurred between a first period of time (a time period before the specific course of action was implemented), and a second period of time (a time period after the specific course of action was implemented).

Next, the system advances to Step 520 where it compares the actual change in the particular measurement of performance with the manager's predicted change in the particular measurement of performance (as provided within the manager's completed action planning survey). For example, if the manager had predicted that the proposed specific course of action would result in a 30% increase in tenant renewal rates, and the actual increase of tenant renewal rates calculated at Step 515 was 15%, in various embodiments, the system would determine that the actual increase in tenant renewal rates was 50% of the manager's predicted tenant renewal rate.

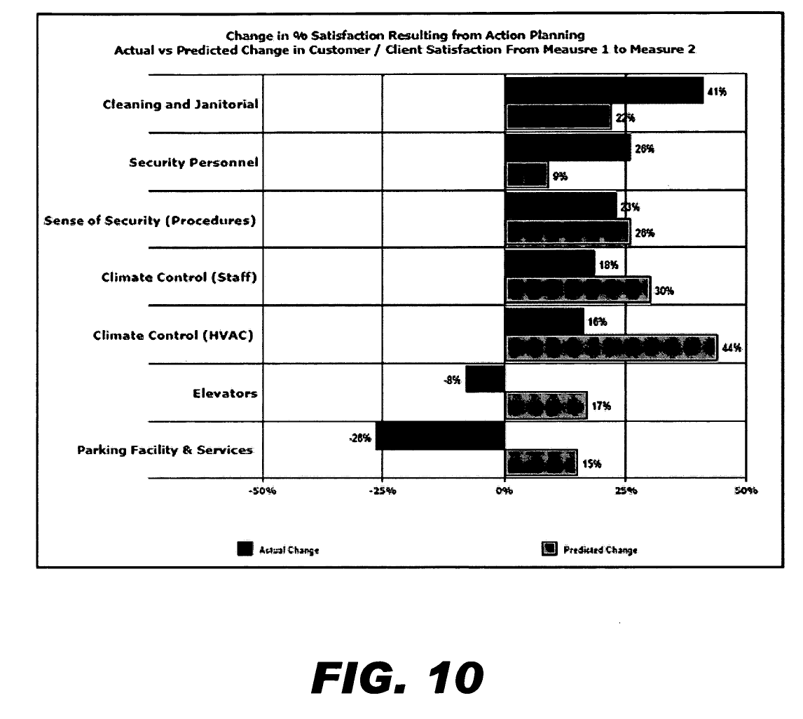

In various embodiments, the system may next proceed to Step 525 where it generates a report that includes a graphical comparison of the actual change in the particular measurement of performance with the manager's predicted change in the particular measurement of performance. An example of such a figure is shown in FIG. 10. As may be understood from this figure, in various embodiments, the graphical representation may include, for each of a plurality of areas, a side-by-side bar-graph comparison of the actual change in the particular measurement of performance with the manager's predicted change in the particular measurement of performance.

Next, the system proceeds to Step 530 where it distributes the report generated at Step 525 to one or more pre-determined individuals, such as one or more of the manager's superiors. These pre-determined individuals may then use the report, for example, to assess the manager's job performance (e.g., how well the manager understands the impact that taking certain actions would have on, for example, customer satisfaction). The pre-determined individuals may further use the report to assess whether the manager requires additional training, and for determining, at least partially, one or more aspects of the manager's future compensation.

Immediate Reporting Feature

In various embodiments of the invention, the system also includes various features to facilitate access to information within the system. For example, in various embodiments, the system may be configured, for one or more particular surveys, to forward a particular individual or organization's completed survey in response to receiving the completed survey from the individual or organization. In various embodiments, the system is configured to forward the completed survey to one or more predetermined individuals or organizations substantially immediately after receiving the completed survey. In various embodiments, this forwarding process may occur automatically via e-mail. Alternatively, the results may be posted to a web site, and the system may automatically generate and send a notification (e.g., via e-mail) to one or more individuals upon receiving one or more particular completed surveys.

For example, in a situation where Tenant A is Manager A's most important client, the system may be configured to forward, to Manager A, any completed surveys received from Tenant A substantially immediately upon receipt of the completed surveys. As noted above, this forwarding process may be completed, for example, via e-mail.

Ad Hoc Reporting Feature

In various embodiments, the system may be configured to allow users to search the results of completed surveys in a variety of different ways. For example, in various embodiments, the system may be configured to allow users to search for all responses in which a particular question was answered in a particular way (for example, for all responses in which the survey participant answered a particular question by indicating that a particular topic was “Very Important” to them). This may be useful, for example, in determining what type of users have answered a particular question in a particular way.

### CONCLUSION

Many modifications and other embodiments of the invention will come to mind to one skilled in the art to which this invention pertains having the benefit of the teachings presented in the foregoing descriptions and the associated drawings. Accordingly, it should be understood that the invention is not to be limited to the specific embodiments disclosed and that modifications and other embodiments are intended to be included within the scope of the invention. Although specific terms are employed herein, they are used in a generic and descriptive sense only and not for purposes of limitation.

We claim:

1. A system for use in evaluating the performance of an individual, said system being adapted for:
(A) generating a survey regarding at least one particular topic;
(B) distributing said survey to a plurality of survey participants;
(C) receiving a set of results of said survey;
(D) analyzing said set of results to identify:
(1) at least one target area for improvement, and
(2) a first target area performance measurement that corresponds to a particular measurement of performance within said target area at a first particular time;
(E) receiving a quantified estimate of the effect that the completion of a particular course of action would have on said particular measurement of performance within said target area, said quantified estimate being made by said individual and comprising a predicted change in said particular measurement of performance within said target area;
(F) distributing said quantified estimate to at least one superior of said individual;
(G) after the completion of a particular course of action, receiving a second target area performance measurement that corresponds to said particular measurement of performance within said target area at a second particular time, said second particular time being after the completion of a particular course of action;
(H) comparing said second target area performance measurement with said first target area performance measurement to determine an actual change in said particular measurement of performance within said target area; and
(I) generating a comparison of said actual change in said particular measurement of performance with said predicted change.

2. The system of claim 1, wherein said system is further adapted for:
(J) distributing said comparison to said superior of said individual.

3. A system for use in evaluating the performance of an individual, said system being adapted for:
(A) analyzing a first set of data to determine:
(1) at least one target area for improvement, and
(2) a first target area performance measurement that corresponds to a particular measurement of performance within said target area at a first particular time;
(B) receiving a recommendation of a specific course of action that would produce a measurable improvement in said particular measurement of performance;
(C) after the implementation of the specific course of action, receiving a second target area performance measurement that corresponds to said particular measurement of performance within said target area at a second particular time, said second particular time being after said occurrence of said implementation of said specific course of action;
(D) using said second target area performance measurement and said first target area performance measurement to determine a change in said particular measurement of performance; and
(E) conveying said change to a user.
